(19) United States
(12) Patent Application Publication
(10) Pub. No.: US 2004/0139638 A1
(43) Pub. Date: Jul. 22, 2004

(54) Notice board structure

(76) Inventor: Angela Liao, Taipei (TW)

Correspondence Address: Angela Liao, P.O. Box No. 6-57, Chung Ho, Taipei, 235, TW

(21) Appl. No.: 10/345,267

(22) Filed: Jan. 16, 2003

(51) Int. Cl. G09F 7/00

(52) U.S. Cl. 40/605

(57) ABSTRACT

A notice board structure which can be expanded laterally to obtain a diversified noting effect. The notice board includes a baseboard, male connectors, female connectors, a designated part, and fastening members. The baseboard has the male connectors fixedly disposed on the right, left, up, and bottom sides. The male connectors at each side of the baseboard can connect with female connectors, whereas the female connectors can connect with the male connectors of additional notice boards such that the purpose of connecting a plurality of notice boards can be attained. The surface of the baseboard for the notice board is engaged with the designated part, which can attain a diversified noticing effect by applying different types of designated parts.

### BACKGROUND OF THE INVENTION

1) Field of the Invention

The present invention relates to a notice board, more particularly to a notice board to be made in one unit with a male connectors on four sides; male connectors of two notice boards can be connected through a female connector. The baseboard has engaging slots, which allow writings to engage with the notice board to complete the assembly.

2) Description of the Prior Art

There are many occasions in life notice boards being used such as doorplates at the main entrance, nameplates, and placards in the neighborhood with a designating and noting effect. However, these notice boards are made for their specific purposes and hung in the location of designation to obtain a noting effect. Once the designated contents need to be changed or increased, the notice boards have to be re-made or to be added another notice board. No matter by reproduction or repurchasing the notice boards are hard to conform with the original ones due to the differences in colors, dimensions or types, and the original and new notice boards being placed together are less collocated with a parallax in sight. When the original notice boards do not fit for the present usage, or the contents need to be modified, a new notice board is required. The disassembly of the original notice boards for the replacement of the new notice boards is a waste of labor, money, and time for a great inconvenience. The conventional notice board is made by the material of plane or convexity which does not have an illuminated effect in a dark environment and causes a discerning difficulty.

Due to the inconvenience of replacement by any variations in contents, the waste of money, and other drawbacks in usage, some improvements need to make for the conventional notice board.

### SUMMARY OF THE INVENTION

The primary objective of the present invention is to provide a notice board structure, which includes a baseboard having male connectors on the right, left, up, and bottom sides thereof. The male connector can be connected to a female connector and the female connector can connect with another notice board to obtain the effect by assembling a plurality notice boards together.

The second objective of the present invention is to provide a notice board structure, wherein, the baseboard has male connectors on the right, left, up, and bottom sides thereof. The male connector can engage with a female connector, subsequently, and each side of the notice board can also be engaged in connection with additional notice boards to expand the notice board in unlimited numbers.

The other objective of the present invention is to provide a designated part which can be digits, writings, or patterns to obtain different designated effects.

Another objective of the present invention is to provide a designated part made by illuminated components to obtain the effects of light illuminating, reflecting, and storaging. The illuminated components can either be applied by using electricity or non-electricity.

The further objective of the present invention is to have engaging slots enabling patterns or writings to fit into the baseboard for the replacement without discarding the baseboard and no screw being used during the assembly.

The further objective of the present invention is to provide fastening members on the baseboard to fixedly place the notice board on walls, sidings, doorplates, planking, or metal plates. The baseboard can be disassembled and placed in different locations easily; the number of the baseboard can be increased or reduced by demands due to the convenience of assembly.

To enable a further understanding of the said objectives as well as other objectives and structure details of the invention herein, the detailed description of the invention herein along with the brief description of the drawings below shall provide additional elaboration.

### BRIEF DESCRIPTION OF THE DRAWINGS

FIG. 1 is a perspective exploded view of the present invention.

FIG. 2 is a side view of the present invention.

FIG. 3 is a perspective exploded view of a preferred embodiment of the present invention.

FIG. 4 is a perspective exploded view of another preferred embodiment of the present invention.

FIG. 5 is a front view of a preferred embodiment of the present invention.

FIG. 6 is a side view of a preferred embodiment of the present invention.

### DESCRIPTION OF THE PREFERRED EMBODIMENTS

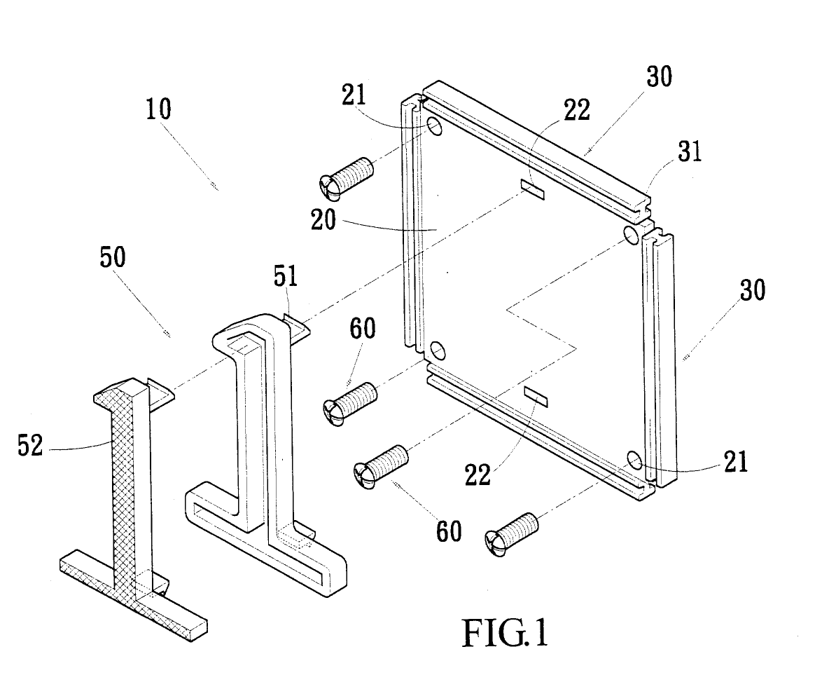

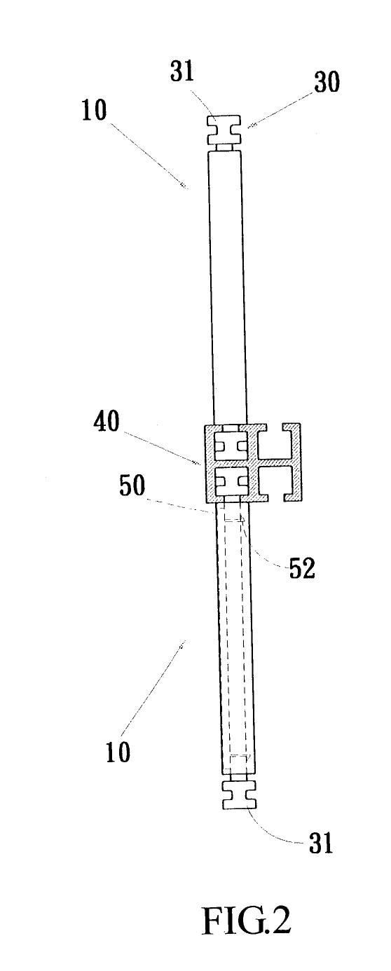

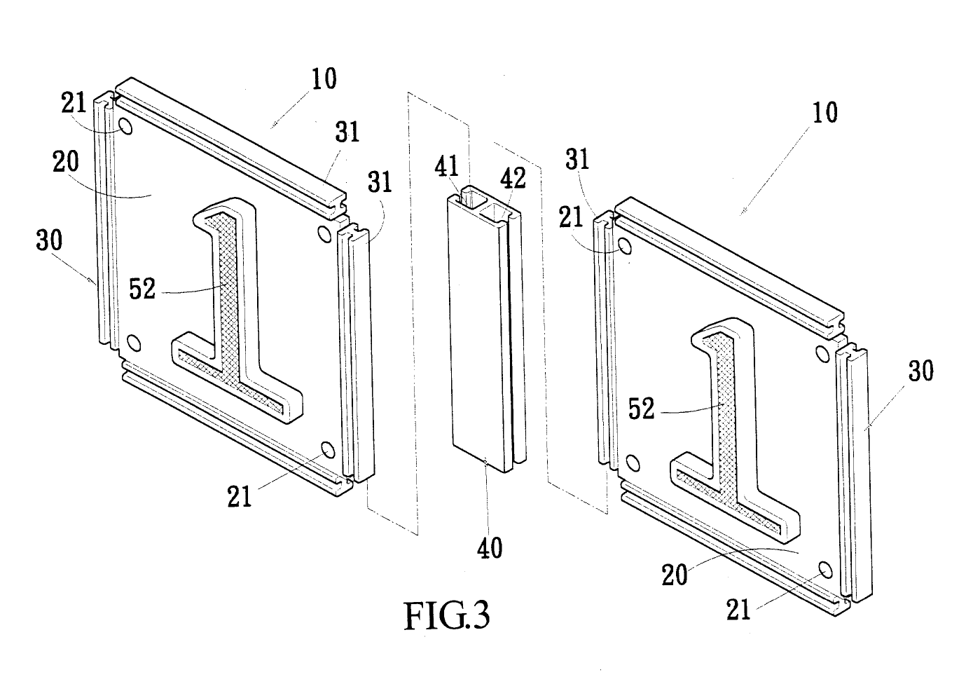

Referring to FIG. 1, FIG. 2, and FIG. 3, a perspective exploded view, a side view of the present invention, along with a perspective exploded view illustrating the present invention, the being assembled notice board structure is comprised of a baseboard 20, male connectors 30, female connectors 40, a designated part 50, and a plurality of fastening members 60, wherein:

The baseboard 20 has receiving holes 21 located near each corner and engaging slots 22 near upside and bottom side.

The male connectors 30 are disposed on each side of the baseboard 20; the male connectors 30 is by I-shaped and an integral part 31 is formed on the top of the male connector 30.

The female connector 40, which is H-shaped with inward hooks on two opposite ends having two mounting slots 41, 42, in connection with the male connector 30.

The designated part 50 fixedly engages on the surface of the baseboard 20; the designated part 50 has protruding portions 51 respectively disposed on the top and the bottom of the back side thereof, and has illuminated components 52 on the surface of the front side. The illuminated components 52 are made of Long-Lasting Phosphorescents with the reflecting effect on the top layer and illuminating effect on the bottom layer to obtain a long-lasting illuminating function. The designated part 50 can be appliced for articles with a designating effect such as writings, digits, patterns, symbols, or constructive components.

A plurality of fastening members 60 can be screw-fastened into the receiving holes 21 of the baseboard 20 in order to apply the baseboard 20 being fixed on articles whatever necessary.

The male connectors 30 are disposed on each side of the baseboard 20, alternatively, it can also be made in one unit with the baseboard 20 during manufacturing process. The surface of the baseboard 20 has a designated part 50 includes the illuminated components 52 and the protruding portions 51, which are composed together and further engage with the engaging slots 22 on the baseboard 20. Thus, the designated part 50 is fixedly placed on the surface of the baseboard 20. The baseboard 20 is securely locked in a reserved location through fastening members 60 to complete the assembly of the notice board.

The surface of the baseboard 20 for the notice board 10 can be replaced by a magnetism corresponds to the designated part on which one side of the surface is also a magnetism, enabling the designated part 50 affract on the surface of the baseboard 20. The designated part 50 also can be placed on the baseboard 20 by the way of agglutination. The designated part 50 placed on the baseboard 20 can be changed for writtings, digits, or patterns in whatever way of fastening.

The designated part 50 applying to the present invention has the effect of light storage, reflection, and illuminating, which can emit light without power sources and further attain the purposes of warning, designation, and noting.

The designated part 50 also can be made by luminescence plates or LED lamps, neon lamp tubes with different illuminated effects and minimum wattage under a long period of usage.

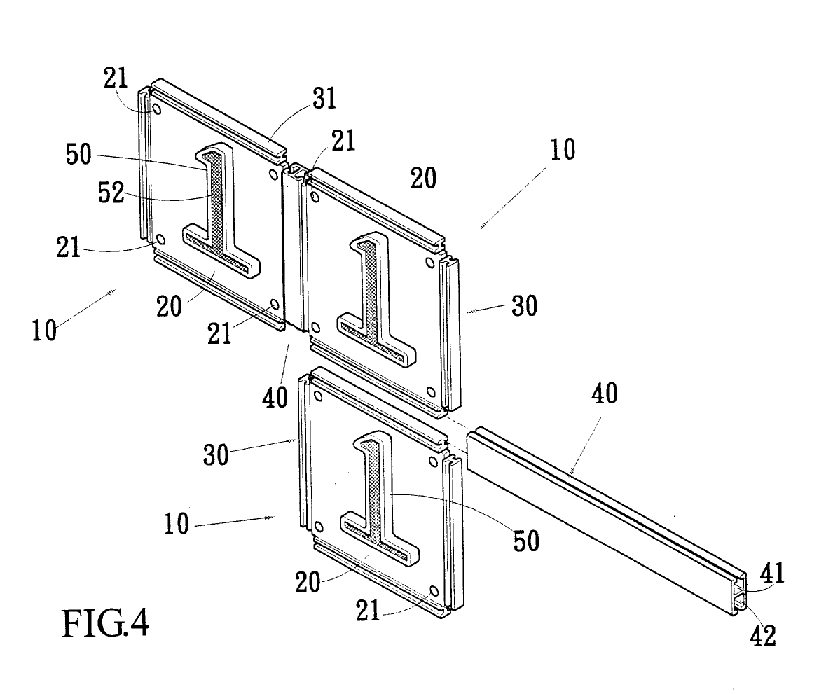

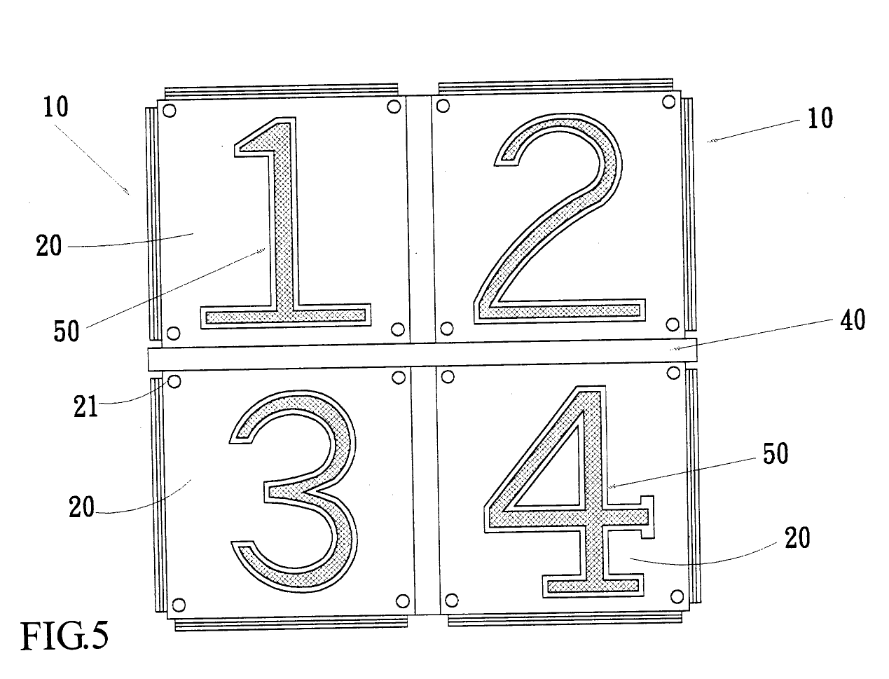

Referring to FIG. 3, FIG. 4, and FIG. 5, two perspective exploded views and a front view of a preferred embodiment of the present invention, in case the notice board 10 is required to increase advertisement area, an integral part 31 of the male connector 30 on the notice board 10 can be connected with a mounting slot 41 of the female connector 40. The other mounting slot 42 of the female connector 40 can be connected with the integral part 31 of the male connector 30 on the other notice board 10, so to achieve the effect of connecting two notice boards 10. The male connectors 30 on each side of the notice board 10 can be connected with the female connectors 40, which can attain the purpose of expanding from each side of the notice board. The surface of the baseboard 20 for all notice boards 10 can be placed different designated parts 50 to create diversified noticing styles and noting effects.

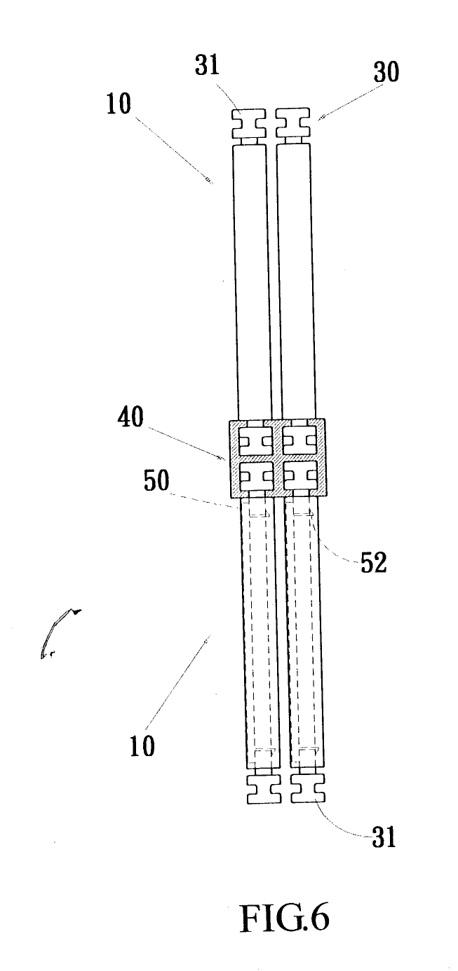

Referring to FIG. 6, a side view of the other preferred embodiment of the present invention, two sides of the female connector 40 are connected with notice boards 10 respectively in functioning advertisement on two sides to increase the noting effect.

In summation of the foregoing sections, the present invention is explained with a practical assembly. It is of course to be understood that the embodiments described herein are merely illustrative of the principles of the invention and that a wide variety of modifications thereto may be effected by persons skilled in the art without departing from the spirit and scope of the invention as set forth in the following claims.

1. A notice board structure comprised of a baseboard, male connectors, female connectors, a designated part, and fastening members, wherein:
the notice board has male connectors on each side of the baseboard; the surface of the baseboard has a designated part and a periphery of the baseboard has fastening members in order to complete the assembly of the notice board; the male connectors on each side of the baseboard connects with the female connectors, whereby the male connectors subsequently connect with the female connectors of an additional notice board to obtain the multiple effect of expanding the notice boards.

2. The notice board structure in accordance with claim 1, wherein, receiving holes are formed near each corner on the baseboard of the notice board.

3. The notice board structure in accordance with claim 1, wherein, engaging slots are formed near upside and bottom side on the baseboard.

4. The notice board structure in accordance with claim 1, wherein, male connectors on each side of the baseboard are I-shaped and, one end of the male connector is fixedly disposed to one side of the baseboard whereas the other end is an integral part thereof.

5. The notice board structure in accordance with claim 1, wherein, protruding portions are formed on one side of the designated part at the top and bottom thereof.

6. The notice board structure in accordance with claim 1, wherein, illuminated components are applied on the designated part on the surface of the baseboard.

7. The notice board structure in accordance with claim 1, wherein, the illuminated components on the designated part are made by Long-Lasting Phosphorescents with the effect of reflecting in the top layer and illuminating in the bottom layer.

8. The notice board structure in accordance with claim 6, wherein, the illuminated components also can be made by luminescence plates, LED lamps, or neon lamp tubes.

9. The notice board structure in accordance with claim 1, wherein, female connectors are H-shaped with two engaging slots used for expanding the notice board.
